(19) United States
(12) Patent Application Publication
(10) Pub. No.: US 2010/0051527 A1
(43) Pub. Date: Mar. 4, 2010

(54) MICROPOROUS FILTER WITH AN ANTIMICROBIAL SOURCE

(76) Inventor: Mikkel Vestergaard Frandsen, Lausanne (CH)

Correspondence Address: JAMES C. WRAY, 1493 CHAIN BRIDGE ROAD, SUITE 300, MCLEAN, VA, 22101, US

(21) Appl. No.: 12/450,046

(22) PCT Filed: Jul. 18, 2007
(86) PCT No.: PCT/DK2007/000362

§ 371 Date: Oct. 16, 2009

(30) Foreign Application Priority Data
Mar. 9, 2007 (DK) PCT/DK2007/000120

(51) Int. Cl. B01D 61/18; C02F 1/00; C02F 1/50

(52) U.S. Cl. 210/209

(57) ABSTRACT

A fluid filtration device having a fluid inlet and a fluid outlet and a confined fluid path between the inlet and the outlet through a microporous filter with a pore size adapted for filtering microbes, for example bacteria and virus. The device comprises an antimicrobial source, preferably halogen source, adding antimicrobial substance to the fluid in the confined fluid path between the fluid inlet end the microporous filter in order to prevent biofilm formation in the microporous filter.

### FIELD OF THE INVENTION

The present invention relates to a fluid filtration device having a fluid inlet and a fluid outlet and a fluid path between the inlet and the outlet through a microporous filter with a pore size adapted for filtering microbes, for example bacteria and virus by mechanical particle size separation.

### BACKGROUND OF THE INVENTION

Typically, household water purification equipment for elimination of microbes in drinking water can follow 2 paths: Chemical deactivation or mechanical filtration.

In case of chemical deactivation, usually, halogenated media, such as Chlorine or Iodine, is being used. For example, in water purification tools, where iodine sources are used, iodine and iodide is released from a resin to the water in order to deactivate microbes, usually, in relative short contact time and dwell time in the water flowing through the device. The deactivation efficacy is a product of the contact and dwell time and the concentration of halogenated media. The shorter the contact-time and dwell-time, the higher the concentration of halogenated media must be to achieve significant microbe deactivation. This high concentration of halogens in the up-taken water by the consumer is leading to taste and odour distortion and may lead to health risks, when permanently used. In order to avoid this negative impact, the residual iodine and iodide is, normally, being removed by an iodine scavenger in a final treatment step before release of the water for consumption. Activated carbon, for example in the granular form (GAC), is a commonly used scavenger, where the activated carbon, in addition, may be treated with silver or copper to enhance an antimicrobial efficiency. As iodine is a rather expensive substance, it is desirable to reduce the iodine consumption.

On the other hand, halogen-free mechanical filters can be used for microbial purification by particle size separation. For example, ceramic filters are known in the art, where the filters can be used for water filtration without iodine or chlorine addition. For example, the companies JP Ceramics Ltd and Fairey Industrial Ceramics Limited (FICL) provide ceramic filters commercially.

In prior art, there are disclosed other systems that are free from halogenic treatment of the water. For example, International patent applications WO98/15342 and WO98/53901 assigned to Prime Water Systems disclose fluid filters with bundles of hollow fibres/tubes having micro-porous fibre walls, through which the water to be treated flows. Microbes are prevented from flow through these walls due to the micro-filtration or ultra-filtration membrane properties of the microporous walls. Depending on the design of the housing, the collected microbes, anorganic sediments and humic acid can be flushed away from the membrane surface to recover the filtration performance, in case the filtrate is piling up to a “filter cake” and clogging the pores of the membrane. Commercial hollow fibre membrane cartridges with forward flush system are also available from the Dutch companies IMT Membranes® and Filtrix®. The capability to clean up and recover the functionality of a membrane surface depends on the flushing power (flow speed) and consistency of the filter cake. Most critical for the shelf life of a membrane is the breeding of a biofilm upstream of the membrane, which is created by mechanically separated, but not deactivated microbes in conjunction with humic acid.

Another example of a halogen-free water filter is disclosed in U.S. Pat. No. 6,838,005 assigned to Argonide and is commercially available as the product with registered trade name Nanoceram® by the company Argonide®. In this case, alumina nanofibres are provided in a porous glass fibre matrix filtering microbes by attachment to the nanofibres. The microbes and anorganic sediments are attracted by the highly electropositive charged alumina and stay permanently, un-releasable in the filter matrix. The shelf life of the filter depends on the level of contaminants in the influent water and the capacity of the filter

The advantages of the halogen-free filters are the relatively long lifetime without re-charge or exchange of halogen source, and the avoidance of halogen taste and possible health impact of the final, released water. However, a disadvantage is the formation of a biofilm inside the filters, leading to clogging of the pores and having the risk for release of a substantial amount of microbes from the biofilm in case of membrane rupture.

In order to prevent clogging of these microbial free filters, backwashing at high pressure is a commonly used method, for example as disclosed in U.S. Pat. No. 6,589,426.

A portable water cleaning device, a photo of which is reproduced in FIG. 11, is commercially available by the company Milleniumpore®. In this device, a water tank 102 is connected via a hose 104 to the lower part of a filtering unit 106. By manually activating a balloon 108, air is pumped into the tank creating pressure driving water from the tank 102 into the filtering unit 106 and after the filtering action out of the filtering unit 6 through, a second hose 110 at the upper part 112 of the filtering unit 106. This second hose 110 is connected to a clean-water tank 114 in which water is accumulated for discharge through third hose 116 if the water level in clean-water tank is above the height of the connection 118 with the third hose 116. When the filter in the filtering unit 106 is clogging, the clean water from the clean-water tank 106 can via hose 110 be pressed backwards into the filtering unit 106 by activation of balloon 120 creating pressure in clean-water tank 114.

To prevent clogging, prior art suggests an antimicrobial source upstream of the microporous filter, for example as disclosed in Different water purification units with antimicrobial killing effect are disclosed in U.S. Pat. No. 3,327,859 by Pall, U.S. Pat. No. 4,769,143 by Deutsch and Iafe, U.S. Pat. No. 5,518,613 by Koczur and Garcia, U.S. Pat. No. 6,454,941 by Cutler et al., International patent application Wo 94/27914 by Hughes, and European Patent application EP 617951 by Shimizu et al.

Furthermore, EP 364 111 by Muramatsu et al. discloses a combination of a carbon filter for removing chlorine and a hollow fibre filter for removing microorganisms. In addition antimicrobial means are disposed between the filters in order to prevent proliferation of microbes on the hollow fibre filter, which otherwise could lead to early clogging of the fibre filter. The antimicrobial means are accomplished by including an antimicrobial agent in or on the material of the hollow fibres, or as an antimicrobial cloth between the fibres. Preferably, the antimicrobial agent is water-insoluble. As a further option, city water with residual chlorine or other sterilizing agent is partially bypassed the carbon filter to reach the hollow fibres.

Thus, there are used two distinct methods for preventing microporous filters, especially hollow fibre filters, from early clogging, wherein one method is addition of an antimicrobial agent and the other is backwash. Both methods have drawback. The first method using antimicrobials has the drawback that the antimicrobial source after certain time may be used up, such that the microbes may proliferate freely in the filter and lead to clogging of the filter. In this case, the filter has to be exchanged, which may become a problem in rural areas. For the second method, the microporous filter is set free from clogging material of breeding microbes when backwashed, but the microbes remain in the filter housing which acts as a microbe incubator leading to faster clogging with time, as biofilm formation on the inner walls of the filter housing promotes proliferation and clogging. In addition, if rupture occurs in the microporous filter without antimicrobial or in the filter, where the antimicrobials are used up, release of the microbe filled water can be fatal for the consumer. Thus, there is a need for a safer and more reliable system.

### DESCRIPTION/SUMMARY OF THE INVENTION

It is therefore the general purpose to improve prior art filters. It is an additional purpose to avoid or at least drastically reduce the risk for release of microbes from microbial breeding inside the filters in case of rupture of a microporous filters.

This purpose is achieved by a fluid filtration device having a fluid inlet and a fluid outlet and a fluid path between the inlet and the outlet through a microporous filter with a pore size adapted for filtering bacteria or bacteria and virus by mechanical particle size separation, further comprising an antimicrobial source adding antimicrobial substance to the fluid in the fluid path between the fluid in let and the inlet surface of the microporous filter and wherein the device has back flush means for pressing clean fluid in a backward direction through the microporous filter.

By providing an antimicrobial source and backwash capabilities, a redundant system is obtained where, on the one hand, the antimicrobial release prevents clogging of the membrane as long as the antimicrobial source is intact, and, on the other hands, the backwash mechanism can be used, especially, when the antimicrobial source is exhausted and filter clogging starts occurring. In addition, biofilm formation on the inner wall of the device is also prevented, which is an advantage, as backwash cannot remove this biofilm. The prevention of formation of biofilm on the inner walls of the device also reduces the clogging frequency of the microporous filter, because there are overall fewer microbes that can breed inside the housing. An additional benefit is the fact that a rupture of the membrane would not lead to substantial danger for the consumer. Thus, not only the lifetime of the filter is increased but also the safety. These factors are crucial, because such filters are important in rural, tropical areas, where access to exchange filters is scarce, and a whole family may be dependent on fresh water production of a relatively small, transportable filter. Thus, the invention is especially useful for small filters that shall have a long lifetime and a high degree of safety.

Typically, the microporous filter is provided in the form of a membrane or a number of membranes. Though seemingly not needing antimicrobial substances, for example halogens, in such porous filters, because microbes are filtered by the pores, the filters are considerably improved, nevertheless, by use of the antimicrobial substance, for example halogens, as the substance prevents the growth of a biofilm in or on the microporous filter, for example on the inlet surface of the a filter membrane, as well as fouling inside the microporous filer, for example inside the filter membrane wall. This is advantageous due to a number of reasons.

By preventing the creation of a biofilm, filtered particles upstream of the microporous filter or on the inlet surface of the microporous filter may be easily flushed out of the device. It has been verified experimentally that a flow pressure of 0.1-0.2 bar is sufficient to flush particles out of filters according to the invention. Thus, the water pa sure obtained in a household filter working with gravity is capable to clean the filter by flushing. This is in sharp contrast to prior art filter cartridges, where a rather high flushing pressure through the filter is needed in order to remove sticky biofilms. The flush at a pressure of 0.2 bar is not powerful enough to remove sticky biofilms in front of a microfiltration or ultrafiltration membrane, for example in the bore of a hollow fiber.

Another advantage of omitting creation of biofilm is understood from the following argument. Biofilm growth in filters may evolve into microbial clusters with the capabilities of releasing vast amounts of microbes to the end user in the case where the porous membranes rupture. Thus, the omission of biofilm growth due to halogenic killing or otherwise antimicrobial killing of the microbes or the mere prevention of microbial growth in the filter reduces the risk for infection in case that the filter is damaged.

The antimicrobial source, preferably halogen source, is upstream of the microporous filter, for example filtration membrane, in contrast to other prior art systems, where halogen is used downstream of a membrane in order to deactivate micro-organisms slipping through the membrane due to a porosity of the membrane not being small enough to separate particles of the corresponding size.

Though the size of the pores has been defined above to be configured for filtering bacteria and virus, it is within the scope of the invention that other biological or non-biological material may be filtered with a device according to the invention. For example, the device according to the invention may be used to filter fingi, parasites, colloidal pesticides or chemicals, humic acid, aerosols and other microparticles from liquid or gases, for example air.

The term filtering bacteria and virus is to be understood as holding back bacteria or virus by mechanical particle size separation from entering or generally traversing the microporous filter medium, as the pores have a size smaller than the microbes for preventing microbes to flow into and through the pores. This is in contrast to the commercially available NanoCeram®, where particles are attracted to nanoalumina particles inside the filter medium due to an electric charge.

The fluid path is confined in such a way that there is a transport of fluid from the inlet through the filter and to the outlet.

It should be mentioned at this point that the singular form “a”, “an” and “the” in the claims and the description is not limiting the invention to a single device but includes as well the plural form unless the context clearly indicates otherwise.

The above mentioned halogen source may be a halogenated liquid or gas that is provided from a reservoir at a suitable rate to the fluid through the device. Alternatively, the halogen source could be a solid media, for example in the form of a tablet or granules, which is/are dissolved at a suitable rate in the flow path. Among suitable candidates in connection with the invention are tablets with high trichloro isocyanic acid content (TCCA). Preferably, this TCCA tablets have a slow dissolving characteristic, which is leading to a low elution of the halogen. Alternatively, a TCCA tablet with high elution characteristic can be installed into a rigid, porous tablet chamber, where influent water is bypassing most of the TCCA tablet chamber, while only a fraction of the influent water penetrates through the tablet chamber. This will lead to dilution of halogenated influent water, which had contact with the TCCA tablet, by the remaining influent water, which was bypassing the TCCA tablet. Alternatively, the halogen source is provided as a halogenated resin located in the path between the inlet and the microporous filter. The concentration of the halogen, for example iodine, may be of a low elution type. Biofilm growth occurs steadily with time, and a filter, which is subject to storage between intermitted use, has growth of biofilm during the storage time due to the remaining fluid in the filter. To prevent biofilm growth, the release of antimicrobial substance is sufficient even at low rate, because the content of antimicrobial substance in the fluid during storage increases steadily.

It should be acknowledged at this point that, usually, a filtration of microbes is not filtering all microbes, but only filters the microbes to a certain degree, generally mentioned as “log reduction” referring to the log 10 of the ratio between the level of contaminants in the inlet fluid and the level of contaminants in the outlet fluid of the filter. For example, a log 4 reduction in contaminants corresponds to 99.99% reduction in contaminants, whereas a log 5 reduction in contaminants corresponds to a 99.999% reduction.

In connection with the filtering device according to the invention, the term “adapted for filtering bacteria or bacteria and virus by mechanical particle size separation” implies a reduction of the microbes in accordance with predetermined reduction levels, for example the above mentioned log 4 or log 5 reduction. In this respect, the reduction levels for bacteria may be different from the reduction level for viruses, because a fairly efficient virus filter may be highly efficient against bacteria due to their larger size.

Thus, if the fluid filtration device is provided with a design flow through the device, wherein the design flow assures a proper filtration of the fluid flowing through the device with a cleaned fluid at the flow outlet, the antimicrobial source, preferably halogen source, may be configured to release the antimicrobial substance, for example halogens, at a rate, which is substantially less than necessary to reduce the microbes in the fluid by a log 4, or even log 3 or log 2, during the time it takes the fluid to flow through the device at the design flow. A design flow may be based on the suction capacity of a human being in the case of a portable suction straw as a device according to the invention. For a household gravity filter, the design flow is dependent on the pressure that is obtained by the height difference between the fluid inlet and the microporous filter and the resistance that is obtained in the microporous filter and possible other media in the device.

Another definition of the low elution antimicrobial is given by the following, Also in this case, it is assumed that the fluid filtration device is provided with a design flow through the device, the design flow assuring a proper filtration of the fluid flowing through the device with a cleaned fluid at the flow outlet. However, in this case, the antimicrobial source, for example a halogen source, is configured to release the antimicrobial substance at a rate, which implies a content of antimicrobials in the fluid after microfiltration of less that a predetermined limit according to a predetermined health protocol. In other words, the amount and rate of release of antimicrobials is selected to such a low level, that a predetermined health protocol, for example WHO protocol, is not violated. Experiments have shown that the level of antimicrobials, for example iodine or chlorine, can be kept so low that they do not violate typical health protocols though still being efficient for preventing biofilm formation and fouling. This is due the relatively long time of action of the antimicrobials on the microbes, for example during storage between intermitted sequences of use.

For example, the rate may be adjusted to yield a relative amount of between 0.01 ppm and 1 ppm, if the halogen is iodine, for example to a concentration of around 0.1 ppm or even less, such as between 1 ppm, 0.5 ppm or 0.1 ppm and 0.01 ppm in the fluid, while the fluid is flowing through the device. A target value in this connection is between 0.01 and 0.05 ppm, preferably in the order of 0.02 ppm, if the device according to the invention is to be operated without iodine scavenger. This is in contrast to the concentration of more than 4 ppm iodine in devices, where a killing of the microbes is necessary during short contact and dwell time with halogen and without microporous filters. In connection with chlorine, the concentration ranges and target values are about a factor of 5 to 10 higher than for iodine, for example between 0.1 and 0.5 ppm, preferably in the order of 0.25 ppm.

It is well known that iodine resins yield a higher concentration of iodine when the resin is new than resin which has been subject to a long term flow of fluid through the resin. Concerning the above mentioned ranges and target values according to the invention, these are directed towards long term values rather than initial values of the resin.

In those cases, where the resin or other halogen source has a sharp high peak value of the released halogen during the very first flow through the device, this sharp peak halogen concentration may be removed by a halogen scavenger after the filter. Optionally, this scavenger may be designed to be used up by the peak value, such that no scavenger is remaining as soon as the peak concentration has been overcome, and the resin or other type of halogen source has entered a quasi steady state halogen release.

The halogen release from the resin or other media, for example a tablet, may be dependent on the temperature, the pH, the flow rate, the viscosity of the fluid and the degree of contamination. However, as the rate of halogen release is not critical for the filtering properties but only has the task to prevent biofilm growth, the influence of these parameters is not crucial. For the low halogen concentration, as mentioned above, the halogen source may be a low elution iodine resin

Typical iodine sources also lead to a certain content of iodide in the fluid.

The term “microporous” refers to pores in the micrometer and/or sub-micrometer range, for example in the range 0.01-1 micrometer. Thus, the term is not limiting the pore size to the micrometer range for micro-filtration but refers equally well to pores that are used for ultra-filtration to filtrate viruses.

Micro-Filtration membranes (MF), typically, have a porosity of about 0.1-0.3 micron and are able to filter bacteria, parasites and anorganic particles bigger than the pores. Ultra-Filtration membranes (UF), typically, have a porosity of about 0.01-0.04 micron and are able to filter bacteria, parasites, and anorganic particles bigger than the pores and virus. MF membranes have normally higher flow rates than UF membranes. The porosity according to the above figures is related to the well known test method for this kind of filters termed bubble point measurement, which also relates to the figures as mentioned in connection with the invention.

The microporous membranes, be it in a tubular form or sheet-like, may be produced with various porosities for particle size separation. In order for the micropores to filtrate bacteria, micropores of the size between 0.1 micrometer and 0.3 micrometer are applicable, whereas to filter viruses, smaller pore sizes are required, for example pores in the range between 0.01 and 0.04 micrometer.

A preferred microporous filter device according to the invention has a porosity of around 0.1 micrometer, for example between 0.05 and 0.15 micrometer, if used for filtration of bacteria.

Typically, in the US, according to the EPA protocol, filters are tested in order to yield a filtration of log 4 for the bacteriophage MS2 virus having a size of 20 nm-30 nm. However, among the viruses dangerous for humans and typically present in tropical countries' water supplies, only the polio virus has this similar size. Other viruses that are dangerous for humans are typically larger, such as the Rotavirus with a size of around 70 nm. In as much as the polio virus is very scarce on Earth, it would suffice in many situations to have a log 4 reduction on viruses with a size larger than 50 nm.

There are UF membranes on the market that deliver reasonable flow at low working pressure. From Prime Water International®, an ultra-filtration single bore hollow tube membrane with 0.02 micrometer porosity is available which has a clean water flux of ˜1000 liters/h×m²×bar, based on single bores flux measurement, where h is the hour, m² is the area in square meters, and bar refers to the pressure. Another candidate as a microporous filter in connection with the invention is commercially available from INGE AG® as an ultra-filtration 7-bore hollow tube membrane having a flux of 700 liters/h×m²×bar. For example, a filter module of a size of ˜30 mm diameter×250 mm length (about the size as the commercially available Lifestraw®) may host between 0.08 and 0.3 m², for example between 0.08 and 0.15 m², active membrane surface area (average 0.20 m²), depending on the outer diameter and number of the fibers in the filter housing.

Using a filter according to the invention as a gravity filter, also sometimes commonly called a siphon filter, implies that at a 1 meter pressure difference of 0.1 bar, a cartridge of 0.1 m² membrane area provides a theoretical flow in the order of 10 litres per hour.

Another possible type of microporous filter for the invention may be of the ceramic type. For example, such membranes may be used in the form of one or more sheets, the latter being stacked in order to provide a large filtration surface.

In order to remove taste and odour of any upstream released halogen, the filter according to the invention is possibly provided with a halogen absorbent before the fluid outlet. Several of such halogen absorbers, for example iodine scavengers, are commercially available. One possible candidate is activated carbon, for example in the granular form (GAC) or contained in a fabric, and, potentially, silver enriched. Another possible halogen absorbent in the case of iodine being the halogen, is Dow Marathon A® or Iodosorb®. However, in an ideal case, the elution of halogenated media is so low, that just the build-up of biofilm is being prevented, but no halogen absorbent is needed to reduce the concentration before human uptake. For example CDC (Center for Disease Control, Atlanta, USA) recommends for babies with an age of 0-3 months a maximum daily iodine uptake at permanent consumption of 0.01 mg/day. Based on an assumed water need at this age of 0.5 litre/day, the maximum iodine concentration in the uptaken water should not be higher than 0.02 mg/l. Thus, ideally, the source does not elute more than 0.02 mg iodine per litre water.

As an option, the filtration device according to the invention may comprise an additional filtration step with an electropositive attracting ultrafiltration or microfiltration media, for example Nanoceram®, as also disclosed in U.S. Pat. No. 6,838,005, though experiments have shown that this is not necessary.

In the case of the microporous membrane or membranes being in the form of hollow fibres/tubes, the fluid path may be arranged from inside the fibres to the outside of the fibres. As an option, the halogen absorbent may be provided between the hollow fibres, a configuration that saves overall space of the entire filtration device according to the invention.

In a preferred embodiment, the device comprises a housing or cartridge with the inlet and the outlet and containing the microporous filter and the halogen source. The cartridge may be disposable and contained in a re-usable housing. Alternatively, the device comprises a housing with a rechargeable or exchangeable halogenated resin separate from the microporous filter.

The housing with the hollow fibres is advantageously assembled in a so-called forward-flush configuration. During use of a filtration device according to the invention, filtered bacteria and virus and other particles will be aggregated in the filter and may with time lead to reduced filtration capabilities. Depending on the amount of turbidity by anorganic sediments and on the amount of organic contamination (bacteria, virus and parasites) as well as by other organic particles, like Humic Acid, the flow rate may be dropping very quickly during use, because the pores are clogging. The membranes would then have to be cleaned or replaced to recover performance. In order to regenerate the filter, a forward flush mechanism may be included in the device according to the invention. The flush mechanism may, in practice, be established by providing a second flow path from the fluid inlet through the microporous filter along the porous filter wall to a second outlet but not through the porous filter wall, the second outlet being provided with a valve system for flushing purposes during an open valve state.

The filter membrane is preferably a hydrophilic porous polymer membrane. The polymers normally being used are Polyether sulphone (PES), Polyvinylidene fluoride (PVDF) or Polyacrylonitrile (PAN).

In a further embodiment, the shape of these membranes is preferably as a hollow fiber tube, but alternatively also as flat membrane. The hollow fiber can have a single bore structure or multi bore structure (for example a 7-bore). Single bore fibers are commercially available from companies like Prime Water International® (BE) or X-Flow® (NL); 7-bore fibers are commercially available from companies like IMT® (NL) or INGE® (DE). For a device according to the invention, an IN-OUT filter flow is preferred, because it ensures a more concentrated flush to remove the filter debris.

In order for the device to have storage facilities, especially in the case of the filter being a gravity filter, the device may have a fluid storage container between the microporous filter and the fluid outlet. In order for the fluid storage container not to imply a risk for microbe breeding, it may be provided with an inner antimicrobial surface. Alternatively or additionally, also, a dirty water storage container can be connected to the inlet.

There are numerous possibilities for application of the invention due to its general nature. For example, the invention may be used for a portable water filtering device. Such a portable filtering device may be a drinking straw, for example, with a diameter between 3 centimetre and 6 centimetre, for example in the order of 3 centimeter, and a length between 10 centimetre and 40 centimetre, for example in the order of 25 centimeter, as it is known from the commercially available water filter LifeStraw®. Such drinking straws are especially suitable for camping, hiking and military purposes as well as emergency equipment and water providing aid in rural areas.

Another application is in the form of a gravity filter, where water or other liquid is filled into a first container and flows through the filter into a second container arranged at a lower level such that gravity forces the fluid through the filter. The force on the liquid for the flow through the filter is dependent on the height of the liquid level in the first container relatively to the liquid filter. If the liquid is water and the level is 2 meter over the filter, the pressure is 0.2 bar. As an example, the height may be chosen between 0.2 and 2 meter corresponding to a pressure of 0.02 and 0.2 bar in the case of water. With this principle, there has been achieved a long lasting, cost effective, easy to maintain household filter for the emerging world. The filter works without artificial pressure devices, such as pumps, but just on gravity.

In a preferred embodiment, the microporous filter is hosting in the order of 0.1-0.3 m² membrane surface area. In addition, the filter may be capable of providing in the order of 10 liters per hour at a fluid inlet pressure of 0.1 bar. These are parameter values that have been verified experimentally. In more densely packed membranes, the filter area in a household or portable filter may be of the order of 3 to 10 times larger. Especially if the filter device according to the invention is used for larger water volumes, for example by installing a large facility in or on the roof of a house, the membrane surface area may be much larger than stated above.

A filter according to the invention is primarily directed towards production of drinking water, but water—or other liquids—may be cleaned for other purposes as well, for example, for industrial, medical or scientific purposes.

In certain embodiments, upstream of the filter membrane, a chamber of halogenated media is arranged, for example iodine or chlorine. The media has a low elution characteristic, which implies that it is not supposed to kill the microbes instantly during the relatively short contact time while the water flows through the filter. Instead of this, a small dose of halogenated elements is permanently streaming into the “filter cake”, possibly but not necessarily killing the microorganisms over time and preventing build-up of biofilm.

The advantage of using a low elution dose halogenated resin versus a high dose resin is the following. First of all, a low elution halogenated resin lasts longer than a high elution resin with the same halogen content. Due to the low dose, the use of a halogen scavenger may be avoided without any substantial health impact on the consumer by the halogen. Even if a halogen scavenger is used, the requirements for the scavenging properties are lower. Also, the low dose allows the amount of resin and scavenger to be small, which reduces the size, weight and costs of a filtering device according to the invention relative to prior art devices.

In order to assure that microbes do not breed inside the filter, in case that some of the microbes enter the membrane, the membrane material may comprise an antimicrobial substance, for example incorporated in the material itself. Examples of such substances are AEGIS Microbe Shield® or colloidal silver.

In specific embodiments, the fluid filtration device according to the invention comprises a housing, inside which the microporous filer is provided. The housing may have an inner wall releasing antimicrobials. An antimicrobial coating prevents biofilm formation on the surface of the inner wall of the housing.

A large number of different coatings are available. Examples of antimicrobial organosilane coatings are disclosed in U.S. Pat. No. 6,762,172, U.S. Pat. No. 6,632,805, U.S. Pat. No. 6,469,120, U.S. Pat. No. 6,120,587, U.S. Pat. No. 5,959,014, U.S. Pat. No. 5,954,869, U.S. Pat. No. 6,113,815, U.S. Pat. No. 6,712,121, U.S. Pat. No. 6,528,472, and U.S. Pat. No. 4,282,366.

Another possibility is an antimicrobial coating that contains silver, for example in the form of colloidal silver. Colloidal silver comprising silver nanoparticles (1 nm to 100 nm) can be suspended in a matrix. For example, the silver colloids can be released from minerals such as zeolites, which have an open porous structure. Silver can also be embedded in a matrix such as a polymer surface film. Alternatively, it may be embedded in the matrix of the entire polymer during plastic forming processes, typically known as injection moulding, extrusion or blow moulding.

A silver containing ceramic, applicable for the invention, is disclosed in U.S. Pat. No. 6,924,325 by Qian. Silver for water treatment is disclosed in U.S. Pat. No. 6,827,874 by Souter et al, U.S. Pat. No. 6,551,609 by King, and it is known in general to use silver enhanced granular carbon for water purification. Silver coating for water tanks is disclosed in European patent application EP1647527.

Other antimicrobial metals that may be employed in connection with the invention are copper and zinc, which, alternatively or in addition, may be incorporated in an antimicrobial coating. An antimicrobial coating containing silver and other metals is disclosed in U.S. Pat. No. 4,906,466 by Edwards and references therein.

A coating may, in addition or alternatively, comprise titanium dioxide. Titanium dioxide can be applied as a thin film that is synthesized by sol-gel methods. As anatase TiO₂ is a photo catalyst, thin films with titanium dioxide are useful on external surfaces that are exposed to UV and ambient light. Also, nanocrystals of titanium dioxide may be embedded within polymers. In addition, silver nanoparticles can be complexed with titanium dioxide for enhanced effectiveness.

For example, a thin film coating may have a thickness as little as a few micrometers. A coating may in addition, or alternatively, comprise a reactive silane quaternary ammonium compound, like it is known from the company AEGIS® under the trademark Microbe Shield™ used for air conditioning. When applied as a liquid to a material, the active ingredient in the AEGIS® Antimicrobial forms a colourless, odourless, positively charged polymer coating, which chemically bonds & is virtually irremovable from the treated surface.

From the inner wall, release of antimicrobials may be provided to an extent that only prevents microbes to live on the surface of the wall and prevent biofilm formation, but it may also be provided to an extent, which involves a release of antimicrobials at a rate which suffices to provide the fluid with enough antimicrobials, such that biofilm formation is also prevented in and on the microporous filter.

In this connection, the following observation is important. When filters of the kind of the inventions are used in rural areas as a clean water filter for a family, the filter is repeatedly used only during short time intervals. Water is typically fetched at a water hole or at the nearby river and is subsequently filtered. This occurs several times a day but only during short time. This implies that the filter is without flow most of the time. In case that the surface of the inner wall is provided with an antimicrobial, the release of the antimicrobial does not need to provide all the water through the filter with a certain dose of antimicrobial substance. It suffices that the release is at a rate that the content of antimicrobials in the time lapses between the filtering gets high enough to prevent biofilm formation. Thus, by taking this filtering habit into consideration, even a low elution of antimicrobials released from the inner walls of the housing is sufficient to prevent fouling and biofilm production. The need of only low elution facilitates the provision of long lasting antimicrobial housings.

The release of antimicrobials from the inner wall of the housing may be caused by a surface coating of the inner surface, for example a surface coating releasing silver, as described above. An alternative is an inner wall with a surface through which antimicrobials are possible to migrate from inside the wall, for example, due to antimicrobials that are incorporated in the material of the wall or due to antimicrobials that are provided in a reservoir behind the wall and which are capable of migrating through the wall and into the fluid in the housing. The inner wall of the housing may be configured as part of a laminate also containing the reservoir.

The term housing also implies multiple housings and tubings between these multiple housings as well as a device according to the invention with interconnected multiple containers.

As mentioned above, during use of the device according to the invention, microbes are accumulated in the fluid upstream of the microporous filter. These microbes can be released and flushed out of the device by a tangential flow along the microporous filter. The first part of the flush fluid released from the device contains a large part of microbes and is hazardous if consumed. As an indication, preferably with a warning, the first outlet for the clean fluid has a first marking and the second outlet for the flush fluid has a second marking, for example a different colour, which is distinctly different from the first marking.

In order to provide an alternative or additional warning, the flush fluid itself can be marked, for example by colour, taste and/or smell. Thus, in a further embodiment, a chamber is provided upstream of the second outlet. This chamber accumulates a certain volume of the fluid from the inlet and adds a marking substance to this part of the fluid in order to provide a certain colour to the volume of fluid when a user opens a valve for release of fluid from the second outlet, the first fluid released is the fluid from the chamber. This volume of the fluid is coloured, for example green or red, and indicates to the user that this fluid is not for consumption. In addition to the colour or alternatively, the fluid may be provided with a substance giving the fluid a special taste, for example a bitter taste, and/or a special smell, for example a fouling smell. In order for the volume of the chamber to be separated from the fluid that traverses the filter, the chamber comprises in a further embodiment a one-way valve separating the chamber from the microporous filter.

During forward flushing, fluid enters through the fluid inlet, flows along the microporous filter surface and exits the device through the second fluid outlet after having traversed the chamber, which is upstream of the second outlet. When the second outlet is closed again, the chamber is filled with new fluid which takes up the marking substance. The marking substance may be provided in small quantities and, thus, gradually builds up in the fluid of the chamber until the next forward flush. The volume of the chamber can be small, as it is only necessary to warn the user shortly when the second outlet is opened. This implies that the source of colour, smell or taste can be a small source, for example a slowly dissolving tablet provided in the chamber.

Preferably, the first fluid outlet is closed during forward flush, though this is not strictly necessary.

It is of advantage, if the microporous filter is treated with some back flush before or during forward flush. The back flush is performed by pressing clean fluid in a backward direction through the microporous filter, for example several times intermitted with forward flush. In a further embodiment, the device has a back flush container connected to the exit side of the microporous filter for back flush of clean fluid from the back flush container and through the microporous filter.

Especially for house hold filters or portable filters the back flush container, advantageously, is a manually activated bellow, for example in the form of a squeeze pump, connected to the exit side of the microporous filter. By manually pressing the bellow together, clean fluid accumulated in the bellow is pressed back into the microporous filter and back washes the filter. Microbes and other microscopic particles are pressed into the volume upstream of the microporous filter. From this upstream volume, the particles are, then, removed by forward flush.

The back flush container, for example a bellow, is connected to the microporous filter in a dead end configuration in a specific embodiment, which means that the bellow has a separate connection to the downstream side of the microporous filter relative to the first outlet.

In certain cases, the device according to the invention has a distinct orientation for proper use. For example, the device according to the invention being a water filter and having a tube-like housing around the microporous filter, the proper use of the device may imply a vertical arrangement of the housing. If the first outlet is in the bottom of the housing, and the backflush container is connected to the upper part of the housing, there is a risk that air is trapped in the backflush container instead of clean water such that proper backflush is not possible. Thus, it is an advantage, if the backflush container is located below the first outlet, because the water level for extraction of water through the first outlet will also fill the container.

Alternatively, the back flush container can be part of a tube connecting the microporous filter with the first outlet. In this case, clean fluid flows through the container, for example bellow, in order to leave the first outlet. Thus, the bellow will easily be filled, at least partly, with clean fluid.

In a specific embodiment, the housing is a tube with a lateral dimension smaller than 6 cm, and the bellow is provided on an outer side of the housing for manual activation by grabbing around the housing and exerting pressure on the bellow. Each time the housing is grabbed by a person, a backflush is activated removing microbes from the pores of the filter.

In specific embodiments, the device according to the invention is a portable filter with a housing and a mouthpiece in connection with the first fluid outlet configured for contact with the mouth of a person. If the mouthpiece, or at least part of it, preferably that part that is provided for contact with the mouth of a person drinking from the mouthpiece, has an antimicrobial surface, the bacteria from one person drinking from the mouthpiece are killed on contact, such that a second person using the mouthpiece is not infected. In this case, the invention is especially suited for compact water purification devices having dimensions as the commercial product with the registered trademark LifeStraw®.

Generally, if the housing, or at least part of the housing of the device according to the invention, preferably that part of the housing that is configured for hand contact with the housing, has an antimicrobial surface, the bacteria or other microbes from one person holding the housing are killed on contact, such that the second person touching the housing is not infected by microbes on the housing. Also, even if the filter is stored in an unhygienic place it does not become a bacteria breeding ground.

In other above mentioned embodiments, the device according to the invention is applied as a household filter without a mouthpiece configured for contact with the mouth of a person.

The fluid filtration device according to the invention implies the possibility of a great variety of embodiments as it appears from the foregoing. For example, it may be constructed as a modular device with several modules or as a non-modular device, for example made in one piece. Also, as described above, the device according to the invention may comprise a water purifying granular resin, for example several types of granular resin or only one type of granular resin. In some embodiments, the device does not comprise a first module and a second module containing mutually different water purifying granular resins. Alternatively, the device may be without granular resin at all. By only having one resin or no granular resin, this would imply that there is no need for a separation means for preventing mixing of the resins, for example a permeable mesh with a mesh size smaller than the grain size of the resins. The fluid filtration device may have a mouthpiece configured for contact with the mouth of a person or be made without a mouthpiece. In case that a mouthpiece is used, the mouthpiece may have an antimicrobial surface, but they may also be provided without an antimicrobial surface. The housing, as well, may be provided with an outer or inner antimicrobial surface or without an inner or an outer antimicrobial surface or even without an antimicrobial surface at all.

A number of candidates for microporous filters or electro-active filters usable in connection with the invention including
carbon nanotubes filters,
dendritic polymers,
microsieves and nanosieves
Polyoxometalates
   are found in the following disclosures
Nature Materials 3, 610-614 (2004) by A. Srivastaval, O. N. Srivastaval, S. Talapatra, R. Vajtai2 and P. M. Ajayan.
Cees J. M. van Rijn, Wetze Nijdan, with title “Nanomembranes”, published in Encyclopedia of Nanoscience and Nanotechnology, Vol. 7. pp. 47-82, edited by H. S. Nalwa, American Scientific Publishers, 2004.
“Nanomaterials and Water Purification: Opportunities and Challenges” in Journal of Nanoparticle Research Issue Volume 7, Numbers 4-5/October, 2005, Pages 331-342, edited by Nora Savage and Mamadou S. Diallo, Publisher Springer Netherlands.
T. Yamase and M. T. Pope Polyoxometalate Chemistry for Nano-Composite Design, Kluwer Academic/Plenum Publishers October 2002.

The device according to the invention may be constructed with a variety of antimicrobial sources, as it appears from the foregoing. For example, the device according to the invention may as antimicrobial source use a halogenated resin provided in the path between the fluid inlet and the microporous filter for flow of the fluid through the resin chamber. The halogenated resin may be a granular resin. However, as halogenated resin is a relatively expensive antimicrobial, an antimicrobial source may be used alternatively which is free from granular halogenated resin or free from halogenated resin at all. Instead, a number of other antimicrobial substances may be used, as explained in the foregoing, for example halogenated tablets without halogenated resin. As a further alternative, the filter media, or even the entire device, may be free of antimicrobial resin.

In some embodiments, the fluid filtration device according to the invention is not in the form of a tubular housing with a length of less than 50 cm and a width of less than 80 mm. In some embodiments, the fluid filtration device according to the invention is without a mouthpiece for suction of water through the device. In some embodiments, it has a mouthpiece but the mouthpiece does not have an antimicrobial surface. In some embodiments, it has a mouthpiece and a housing, both of which are without an antimicrobial surface. In some embodiments, the device is without at least a first module and a second module containing mutually different water purifying granular resins, wherein the first module has a first connector and the second module has a second connector, the first and the second connector both being tubular and being connected for confining water flowing through the first and the second modules. In some embodiments, the device is without a first module or a second module or both having at least one water permeable mesh with a mesh size smaller than the grain size of the resins for preventing mixing of the resins.

### SHORT DESCRIPTION OF THE DRAWINGS

The invention will be explained in more detail with reference to the drawing, where

FIG. 1 illustrates the principle of the invention,

FIG. 2 illustrates the flush principle,

FIG. 3 show a stacked membrane configuration,

FIG. 4 shows a zig-zag stacked membrane configuration

FIG. 5 illustrates a hollow fibre arrangement with halogen absorber between the fibres,

FIG. 6 illustrates a hollow fibre arrangement with storage container,

FIG. 7 illustrates a gravity filter,

FIG. 8 illustrates the container of the gravity filter in greater detail

FIG. 9 is a capillary filter with a backflush option,

FIG. 10 is a sheet membrane filter with a backflush option,

FIG. 11 is a reproduced image of a prior art table top system with backflush.

### DETAILED DESCRIPTION/PREFERRED EMBODIMENT

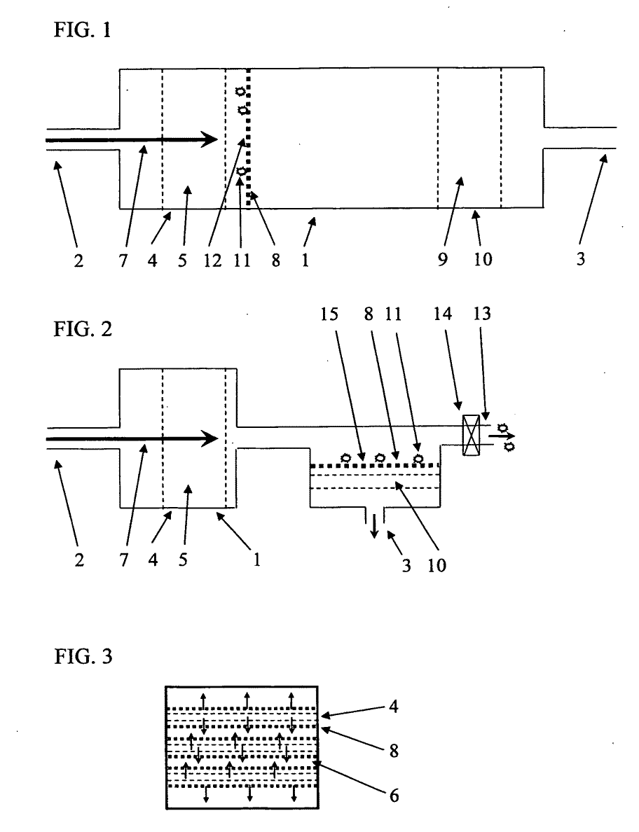

FIG. 1 illustrates the principle of the invention. The fluid filtration device 1 has a fluid inlet 2 and a fluid outlet 3. The fluid is preferably liquid, but the invention is of general nature and may be used for gases, aerosols or vapours as well. Downstream of the fluid inlet 2 is a chamber 4 where an antimicrobial substance 5, preferably halogen, is provided. The source could be a halogenated liquid or gas that is provided at a suitable rate to the fluid through the device. However, preferred is a halogenated resin through which the fluid flows, which is indicated by arrow 7. After the step of adding a halogen to the fluid, the fluid traverses a microporous filter 8, preferably a membrane, before the fluid leaves the device through the fluid outlet 3. Optionally, the device 1 also has a halogen absorber 9 in a third chamber 10. Material 11, such as bacteria, virus, and other material is held back at the microporous inlet surface of the wall 12 of the membrane 8. In a vertical configuration, the device as illustrated in FIG. 1 may be applied with the gravity principle.

The chamber 4 with the antimicrobial substance 5, preferably the halogenated source, for example a resin or tablet, may be an integrated part of the housing 1 or a chamber which can be demounted as a module from the remaining part of the housing for exchange of the chamber 4, for example in the case that the source, for example a resin or tablet, is exhausted. In case that the invention is used as a drinking straws analogous to the commercial product LifeStraw®, the first outlet 3 may be provided with a mouthpiece.

In FIG. 2, the basic principle is illustrated for a device according to the invention having a forward flush mechanism included. The device 1 includes a first fluid outlet 3 for outlet of filtered liquid. This first fluid outlet 3 may, optionally, be provided with a valve for regulation of the flow through the outlet 3. In addition, the device 1 includes a second fluid outlet 13 with a valve 14, which can be opened for flushing situations, where the flushing fluid flows parallel along the membrane surface 15 to take up the filtered debris 11. If the first fluid outlet 3 is provided with a valve, this valve may be closed during flushing situations.

In FIG. 3, a stacked flat membrane configuration is shown in a cross sectional view. The membranes 8 may be of the ceramic type or the microporous polymer membrane type. Water is flowing into the microporous filter between the inlet walls of adjacent membranes 8 and flows out of the microporous filter into the volume 6 between outlet walls of adjacent membranes 8. As the membranes 8 are fitted tightly to the surrounding enclosure, water flow from the inlet to the outlet is only possible through the membranes 8. In the volume 6 between outlet walls of adjacent membranes 8, a halogen absorber, for example an iodine scavenger resin, may be arranged. The stacked membrane configuration may be part of the flushable device principle, an example of which is illustrated in FIG. 2. As an alternative, though not shown, the stacked membranes may be curved. A further alternative may be provided as pairs of spiraling membranes.

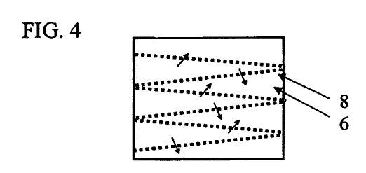

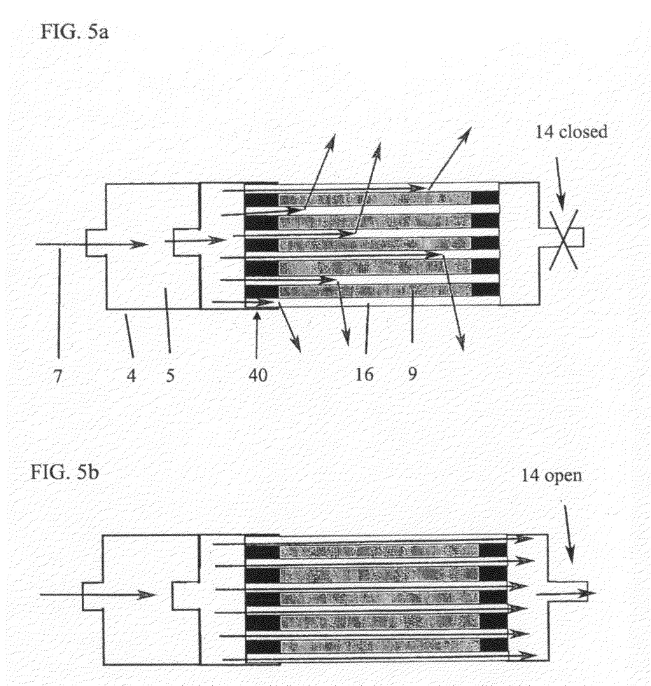

In FIG. 4, a different stacked membrane configuration is shown, where the membranes 8 form a zig-zag pattern. This may be convenient, if the membrane is a foldable microporous membrane 8, which is folded into the harmonica-like form before mounting in a housing. The zig-zag stacked membrane configuration may be part of the flushable device principle, an example of which is illustrated in FIG. 2.

In FIG. 5a, a configuration is illustrated incorporating hollow fibres 16. A plurality of hollow fibres 16 are arranged in a housing 40, and fluid 7 may flow through a chamber 5 with an antimicrobial, for example a halogenated resin 5, and into the fibres 16 before flowing through the fibre walls and out of the filter through the interspaces between the fibres 16, which is illustrated by arrows. In the interspaces between the fibres 16, a halogen absorber 9 may, optionally, be provided in order to take up residual halogen from the fluid before release from the filtering device 1. The antimicrobial substance 5, for example a halogenated resin, as illustrated, may be contained in a rechargeable chamber 4. The hollow fibres 16 are through-going, that means they are not closed at their ends. If the valve 14 is opened, as illustrated in FIG. 5b, the fluid will seek the easiest possible way out through the valve 14. Biomaterial and other material that is retained in the fibres will be flushed out of the fibres 16 by the flow of the fluid.

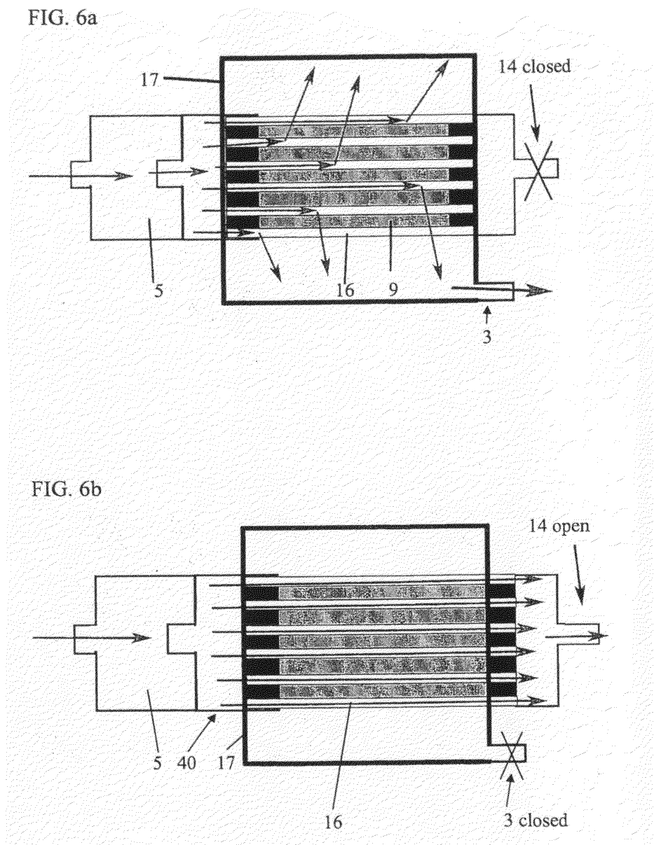

FIGS. 6a and 6b illustrate a similar principle as FIG. 5. However, a storage container 17 surrounds the membranes in order to take up water or other, filtered fluid before release for consumption. The storage container is especially useful in the case of gravity filters, where water may flow through the filter a substantial time prior to consumption. For example, water may flow through the filter during night time and be accumulated in the storage container for consumption the following day.

In one of the embodiments, the storage container 17 is arranged to surround the tubular housing 40 and is made of a flexible material. By grabbing around the housing and the container 40, pressure is exerted on the container. If at the same time, the first outlet 3 is closed, the clean fluid in the container 17 will be pressed back into the interspaces between the fibres 16 and perform a backflush through the fibre walls. The backflush will remove particles and microbes from the inner side of the fibres 16, after which the microbes and particles can be flushed out in the forward flush configuration though opened valve 14 as illustrated in FIG. 6b.

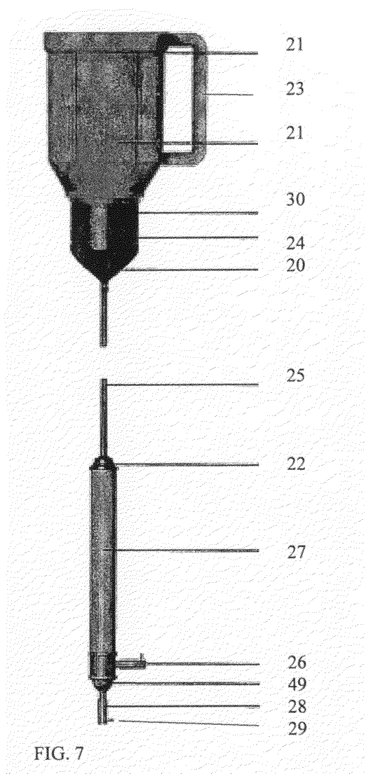

FIG. 7 illustrates a gravity filter 20 with a feeding container 21 for feeding water into the filter device 22 arranged at a lower level. The container 21 is provided with a handle 23 for easy transport of the container 21. The lower part of the container 21 comprises a chamber 24 with antimicrobial substance, preferably a low elusion halogenated source chamber 24, for example containing a chlorinated tablet. Optionally, the container 21 may contain a replacement or cleanable pre filter for filtering larger particles from the water.

The halogenated source chamber 24 of the container 21 is connected to a filter device 22 by a flexible pipe 25. The filter device 22 contains a forward flush configured porous hollow fibre unit, for example with a maximum pore size of 0.04 micrometer or 0.02 micrometer. Apart from a clean water outlet 26 with a valve 27, the filter device also comprises a flush water outlet 28 with a flush valve 29 to be opened for flushing purposes.

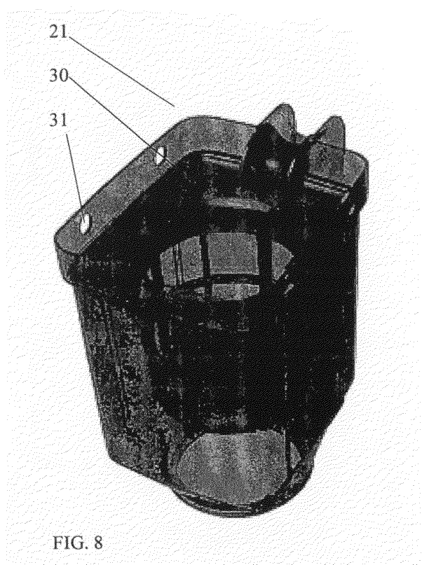

FIG. 8 shows the feeding container 21 in greater detail. A pre-filter insert 30 having a fluid inlet in the upper end is releasably inserted into the container 21. Not shown is a cylindrical replacement filter to be placed in the pre-filter insert 30. The container 21 is provided with holes 31 for hanging the container 21 on a hook or nail in a wall. The handle 23 of the container 21 has a cross sectional U-form for press fit insertion of the filter device 22 into the handle for easy transport and storage.

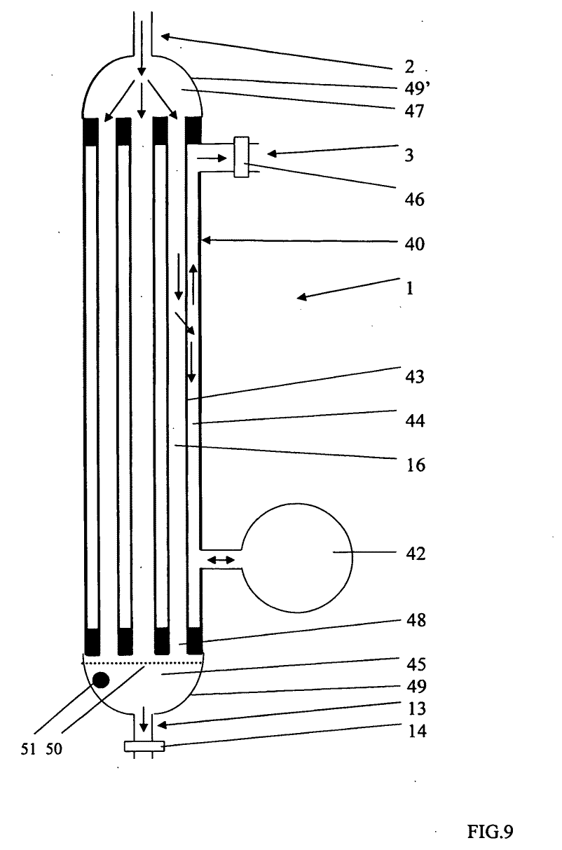

FIG. 9 illustrates a further embodiment of the invention. The microporous filter 1 comprises a number of microporous capillaries 16 into which water or other fluid enters through a fluid inlet 2. The water flows through the capillaries 16 into an outlet chamber 45 in the lower end, from which it can be released through a valve 14 at the second fluid outlet 13 in the case of forward flush. If the valve 14 at the second outlet 13 is closed, the pressure on the water drives the water through the capillary walls 43 and into the interspace 44 between the capillaries. From the interspaces 44, the water can be released for consumption through first outlet 3 having a valve 46 as well. In addition, the filtration device 1 has a container 42 in which clean water is accumulated. As the container 42 is located lower than the first outlet 3, it is filled with clean water before water is released through the first outlet 3. The container 42 is made of a compressable material, for example a polymer bellow that can be manually compressed. When the first outlet is closed by the valve 46, and pressure is exerted on the container 42, pressure drives the water from the container through the capillary walls 43 and back into the capillaries 16. This back flush presses microbes and other particles out of the capillary pores and away from the inner surface of the capillaries 16. A subsequent or simultaneous forward flush through second outlet 13 removes the microbes and particles from the filtration device 1.

In order to provide a proper flow through the filtration device 1, the outlet chamber 45 between the open outlet ends 48 of the capillaries 16 and the second outlet 13 is formed with bending walls 49, for example walls with a semispherical shape. The advantage of such shape is a proper flow without substantial turbulence also for those capillaries that are located close to the housing 40. This is in contrast to a prior art flat end cap, which restricts the flow through the outermost capillaries such that an uneven flow is provided, which is disadvantageous, especially, in forward flush situations. Likewise, an inlet chamber 47 is provided with a bending chamber wall 49′, in order to provide a proper flow into the outermost capillaries.

As an option, the outlet chamber 45 may be delimited by a one way valve 50, allowing water, preferably water, to enter the outlet chamber 45 from the capillaries 16, but which prevents flow back into the capillaries 16. During forward flush situations, the outlet chamber 45 is filled with unfiltered water from the capillaries. When the outlet valve 14 is closed, water is retained in the outlet chamber 45. This water slowly dissolved a tablet 51 which gradually colours the water in the outlet chamber 45 until the next forward flush. At the next forward flush, the first part of the released water has a certain colour and warns the user that this water is not for consumption. As an alternative to the colouring tablet, a granular agent, a coating on the inner surface of the outlet chamber, or a colouring agent incorporated in the material of the walls of the outlet chamber for migration to the inner surface of the walls of the outlet chamber may be used instead. Furthermore, the colouring agent may be substituted or complimented by a taste giving agent and/or a smell giving agent. The one-way valve 50 prevents the added colour, smell or taste giving agent to reach the liquid in the capillaries 16 and the first end.

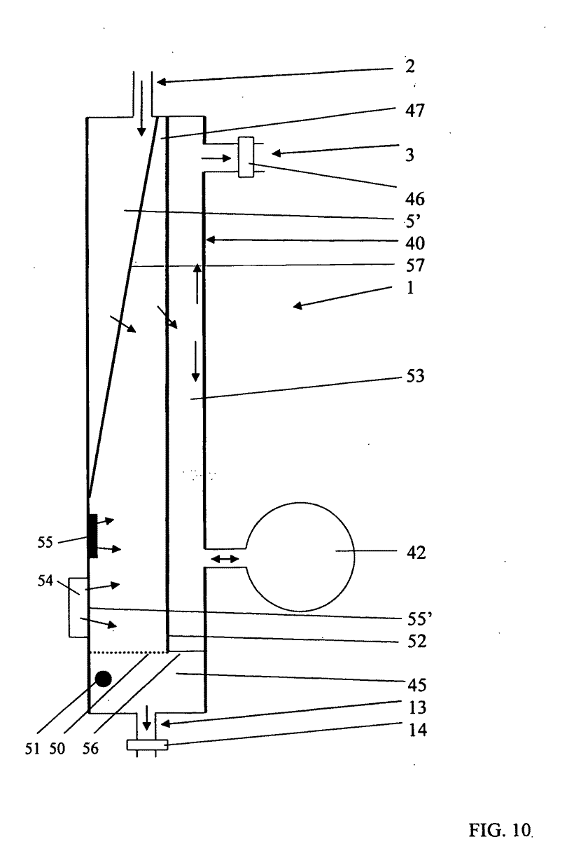

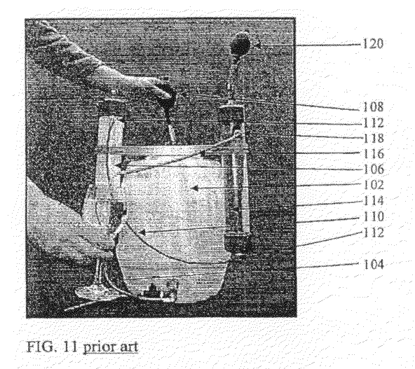

Alternative embodiments are illustrated in FIG. 10. Liquid enters the upper fluid inlet 2 into a first chamber 5′, from which antimicrobial substance is released to the liquid before it enters the inlet chamber 47 through a filter or membrane 57. This antimicrobial substance can be a halogen, preferably iodine or chlorine, from a source in the first chamber 5′. From the inlet chamber 47, the liquid enters the outlet chamber 45 through a one way valve 50 in analogy with the aforementioned embodiment in FIG. 9. If the second outlet valve 14 is closed, liquid traverses microporous membrane 8, for example a ceramic membrane, into an outlet reservoir 53 before it is released through outlet 3 for consumption. Also, in this case, a container 42 is used for backflush through the microporous membrane 8. The outlet chamber is separated from the outlet reservoir 53 by a fluid tight wall partition 56. In addition, the outlet reservoir 53 may contain a halogen scavenger.

As an alternative, or in addition, to the first chamber 5′, there may be added antimicrobial substance to the liquid in the inlet chamber 47 by release from the wall 55 of the inlet chamber, for example by a coating on the inner wall of the housing 40 or by having migratably incorporated antimicrobials in the wall material of the housing 40. As a further alternative, or a further addition, there may be added antimicrobial substance to the liquid in the inlet chamber 47 by migration of the substance from a reservoir 54 and through the wall 55′ of the inlet chamber. From the inner wall 55, 55′, release of antimicrobials may be provided to an extent that only prevents microbes to live on the surface of the wall 55, 55′ and prevent biofilm formation on it, but it may also be provided to an extent, which involves a release of antimicrobials at a rate which suffices to provide the fluid with enough antimicrobials, such that biofilm formation is also prevented in and on the microporous filter 52.

1-63. (canceled)

64. A fluid filtration device having a fluid inlet and a fluid outlet and a fluid path between the fluid inlet and the fluid outlet through a microporous filter with a pore size adapted for filtering microbes from a fluid by mechanical particle size separation, further comprising an antimicrobial source configured for adding antimicrobial substance to fluid in the fluid path between the fluid inlet end the microporous filter, wherein the device has a second flow path from the fluid inlet along the porous filter wall to a second outlet but not through the porous filter wall, the second outlet being provided with a valve system for forward flushing purposes during an open valve state, wherein the device has a back flush container connected to the exit side of the microporous filter for back flush of clean fluid from the back flush container and through the microporous filter.

65. A device according to claim 64, wherein the antimicrobial source comprises a halogen source and the antimicrobial substance comprises halogen.

66. A device according to claim 64, wherein the microporous filter comprises a micro-filtration membrane.

67. A device according to claim 66, wherein the micro-filtration membrane has a porosity of between 0.05-0.4 micrometer.

68. A device according to claim 64, wherein the microporous filter comprises an ultra-filtration membrane having pores with a pore size adapted to filter virus.

69. A device according to claim 68, wherein the ultra-filtration membrane has a porosity of less than 0.04 micrometer.

70. A device according to claim 64, wherein the microporous filter comprises a plurality of hollow, microporous polymer fibres with hydrophilic polymer walls and a flow path through the microporous walls of the fibres, the walls separating the fluid inlet from the fluid outlet

71. A device according to claim 64, wherein the device comprises a halogen scavenger between the microporous wall of the microporous filter and the fluid outlet.

72. A device according to claim 64, wherein the device comprises a housing or cartridge with the inlet and the outlet and containing the microporous filter and the halogen source.

73. A device according to claim 64, wherein the device has a second flow path from the fluid inlet along the porous filter wall to a second outlet but not through the porous filter wall, the second outlet being provided with a valve system for forward flushing purposes during an open valve state.

74. A device according to claim 73, wherein the device has a back flush container connected to the exit side of the microporous filter for back flush of clean fluid from the back flush container and through the microporous filter.

75. A device according to claim 74, wherein the back flush container is a manually activated bellow.

76. A device according to claim 75, wherein the back flush container is connected to the microporous filter in a dead end configuration.

77. A device according to claim 76, wherein the device has a distinct orientation for proper use, in which orientation, the back flush container is located below the first outlet.

78. A device according to claims 74, wherein the housing is a tube with a lateral dimension smaller than 6 cm, and wherein the bellow is provided along an outer side of the housing for manual activation by grabbing around the housing and exerting pressure on the bellow.

79. A device according to claim 74, wherein the bellow is part of a tube connecting the microporous filter with the first outlet.

80. A device according to claim 64, wherein the device has a fluid storage container between the microporous filter and the fluid outlet, the fluid storage container having an inner antimicrobial surface.

81. A device according to claim 64, wherein the device is a portable device.

82. A device according to claim 64, wherein the device is a drinking straw with a mouthpiece for contact with the mouth of a person.

83. A device according to claim 64, wherein the device is a gravity liquid filter.

84. A device according to claim 83, wherein the filter is a gravity filter operating at a pressure of 0.01 and 0.2 bar.

85. A device according to claim 64, wherein the microporous filter is hosting in the order of 0.1-0.5 m² membrane surface area.

86. A device according to claim 64, wherein the device is configured for providing 6-10 liters per hour times inlet pressure in terms of 0.1 bar.

87. A device according to claim 64, wherein the fluid filtration device is provided with a design flow through the device, the design flow assuring a proper filtration of the fluid flowing through the device with a cleaned fluid at the flow outlet, wherein the antimicrobial source, for example a halogen source, is configured to release the antimicrobial substance at a rate, which is substantially smaller than necessary to reduce the microbes by a log 3 reduction in the fluid during the time it takes the fluid to flow through the device at the design flow.

88. A device according to claim 87, wherein the fluid filtration device is provided with a design flow through the device, the design flow assuring a proper filtration of the fluid flowing through the device with a cleaned fluid at the flow outlet, wherein the antimicrobial source is a halogen source configured to release the antimicrobial substance at a rate adjusted to yield a relative amount of less than 1 ppm, if the antimicrobial substance is iodine, and 10 ppm, if the antimicrobial substance is chlorine in the fluid flowing through the device at the design flow.

89. A device according to claim 88, wherein the rate is adjusted to yield an amount less than 0.1 ppm, if the antimicrobial substance is iodine, and between 0.1 and 0.5 ppm, if the antimicrobial substance is chlorine, in the fluid flowing through the device at the design flow.
